(19) United States
(12) Patent Application Publication
(10) Pub. No.: US 2012/0270491 A1
(43) Pub. Date: Oct. 25, 2012

(54) SEALING LIP FOR A VENTILATION FLAP OF A VEHICLE HVAC SYSTEM AND VENTILATION FLAP WITH A SEALING LIP

(76) Inventors: Norman SCHAAKE, Markgroeningen (DE); Alexander Bopp, Illingen (DE); Claude Gietzke, Ilsfeld (DE)

(21) Appl. No.: 13/453,391

(22) Filed: Apr. 23, 2012

(30) Foreign Application Priority Data
Apr. 21, 2011 (DE) 10 2011 007 904.1

(51) Int. Cl. B60H 1/34

(52) U.S. Cl. 454/155; 49/475.1

(57) ABSTRACT

A sealing lip for an edge region of a flap body of a ventilation flap of a vehicle HVAC system is provided. The sealing lip includes a first main side and a second main side opposite to the first main side, whereby the first main side has a plurality of openings.

This nonprovisional application claims priority under 35 U.S.C. §119(a) to German Patent Application No. DE 10 2011 007 904.1, which was filed in Germany on Apr. 21, 2011, and which is herein incorporated by reference.

### BACKGROUND OF THE INVENTION

1. Field of the Invention

The present invention relates to a sealing lip for an edge region of a flap body of a ventilation flap of a vehicle HVAC system and a ventilation flap for a vehicle HVAC system with such a sealing lip.

2. Description of the Background Art

Multiple two-component flaps (2K flaps) are used for HVAC systems in the motor vehicle sector. Sealing lips for 2K flaps are either sharp-edged for high flexibility for sealing or have a hammerhead shape to assure the flexibility in the area of the “hammer shaft.” A thickening in the shaft area and an offset of the flap arms relative to one another are necessary to assure flap stiffness. Alternatively, completely foam-enclosed flaps can have rounded front edges for sealing.

Hissing noises are caused by relatively high flow rates during opening of the stratification flap and separations in the area of the sealing lip front edges. An aerodynamic offsetting of the flap arms is necessary to reinforce the flap axis; likewise, aerodynamically unfavorable reinforcing ribs are necessary. The associated disturbances in the flow produce higher frequency noise components.

DE 295 11 492 U1 shows a ventilation flap for a vehicle HVAC system having a plate body, characterized in that an injected elastomer seal, rooted in a skin of the spray-foam body, is formed in the case of a spray-foamed formation of the plate body.

### SUMMARY OF THE INVENTION

It is therefore an object of the present invention to provide an improved sealing lip for a ventilation flap in a vehicle HVAC system and an improved ventilation flap for a vehicle HVAC system.

In an embodiment, the object is attained by a sealing lip for an edge region of a flap body of a ventilation flap of a vehicle HVAC system and a ventilation flap for a vehicle HVAC system with such a sealing lip according to the main claims.

By equipping a ventilation flap with a soft and rounded sealing lip, which has a plurality of suitable openings or cored-out areas, flow separation of an air stream striking the ventilation flap can be prevented especially effectively or at least reduced.

A 2K flap, which can be produced cost-effectively according to the approach presented here at least partially in an injection mold, is designed so that separations at the edges of the sealing lip, which can lead to undesirable noise generation, can be avoided or at least reduced to a minimum. Slight thickenings of the sealing lips with a radius <1 mm or hammerhead-shaped profiles, as they are often used in the state of the art, can advantageously be omitted. Accordingly, also in case of an unfavorable inflow, e.g., in the case of a shift of the flap from the ideal position parallel to the flow direction and in the case of clearance flows, acoustic disadvantages can be avoided in that pronounced flow separations, which can be present virtually coherently over the flap length and as a result of which hissing noises can occur, can be eliminated totally or at least for the most part according to the approach presented here.

Furthermore, according to an embodiment, an offset of both flap arms to reinforce the flap shaft and use of reinforcement ribs, removed relatively far from one another but relatively high, on the flap is no longer necessary. These would generate in particular acoustically and aerodynamically disadvantageous strong flow disturbances. In fact, completely foam-enclosed flaps also offer aerodynamic advantages, but, in contrast to the flaps produced according to the concept proposed here, their production would be very complicated and costly.

According to an embodiment, a combination of a soft component shape that is rounded but still with sufficient flexibility for reliable sealing, and a flap shape of the hard part of the flap for a favorable flow that provides a sufficient stiffness in the axis area and flap surface area, can be made possible.

In the case of a 2K flap fashioned according to the concept presented here, e.g., about 1 mm<R<2 mm applies to a radius R of the employed sealing lip. A transition from the sealing lip area to the flap body is made aerodynamically efficient without separation edges. For example, narrow areas for increasing the flexibility are realized.

Accordingly, pronounced aerodynamic and acoustic advantages with simultaneously still reasonable production costs result based on the 2-component flap concept presented here through an advantageous shaping of the sealing lips and use of many relatively narrow reinforcement ribs, both in the inflow behavior and also relative to flow over or around a flap.

Advantageously, according to an embodiment considerable aerodynamic and acoustic advantages result over the entire flap adjustment range. No hissing or whistling noises arise compared with a standard flap in the 2K method. The production costs of such optimized 2K flaps are only about twice to three times as high as for a standard flap. For a completely foam-enclosed flap, in contrast, the cost would be higher by a factor of about 4 to 5.

The present invention creates a sealing lip for an edge region of a flap body of a ventilation flap of a vehicle HVAC system, whereby the sealing lip has a first main side and a second main side opposite to the first main side, characterized in that the first main side has a plurality of openings.

The ventilation flap can be used to regulate a flow of one or a plurality of differently conditioned air streams to an air mixer of the vehicle HVAC system, said mixer from which a passenger compartment of the vehicle can be supplied with fresh air or heated. To control an air stream mixture ratio, the ventilation flap can be arranged rotatable on a shaft. The flap body can be a rigid element of the ventilation flap, which determines the general form thereof. The flap body can be made of a plastic or metal material and have two substantially rectangular, flat flap wings, which with a predetermined angle can be arranged on a thickened shaft area of the flap body. Over the shaft area, the ventilation flap can be arranged on the shaft and be positioned relative to the air streams to control their flow in the vehicle HVAC system.

The sealing lip can be designed, for example, of a soft elastic material and have substantially a shape of a flat band rounded off on one side, whereby two opposite wide sides of the band form the first and the second main side. In the attached state of the sealing lip to the flap body, the rounded area can be located on the outside and can easily be curved up or down. The sealing lip can run around the entire flap body or only around a flap wing of the flap body. In so doing, the sealing lip can be disposed only at a straight edge of the flap wing or also be placed around the corners or edges of the flap wing. To this end, the shape of the sealing lip can be matched to the edge area of the flap wing. The sealing lip can be placed on the edge region or be connected in a different fashion to the edge region, for example, via an adhesive bond. The sealing lip can be of variable width; e.g., an end section of the sealing lip can have only about half the width of the rest of the sealing lip. An end section of this kind can be designed, e.g., without openings. The openings can be holes, which pierce a surface of the first main side. A cross section of the openings can be round or angular. The openings can also have identical or different cross sections. The plurality of openings can extend perpendicular to a surface of the first main side of the sealing lip. For example, a distance from the walls, forming the openings, of the interior region of the sealing lip can be uniform over an entire extent of the openings. The plurality of openings can be distributed uniformly over an entire region of the first main side or at least over a major part of an entire surface of the first main side. For example, an edge strip, facing the flap body, of the first main side can be free of openings. An area between the edge strips and a beginning of the curvature, by which the first main side merges into the second main side, can have the plurality of openings. The plurality of openings can cover half or more than half of an entire surface of the first main side. Advantageously, it can be achieved by the uniform distribution of the openings over the entire first main side that an air stream, striking the ventilation flap, is taken up uniformly and can be carried further free of flow separation. Thus, air turbulences can be avoided over an entire width of a flap wing. Alternatively or in addition, the second main side of the sealing lip can have suitable openings.

According to an embodiment, a bar arranged between two adjacent openings of the plurality of openings can have a smaller width than each of the two adjacent openings individually. The bar can be formed by the material of the sealing lip and end with an outer surface of the sealing lip. The sealing lip can have a plurality of bars, which extend between the plurality of openings. The bars can have a lattice structure. The walls of the openings can be formed by the bars, on the one hand, and retain the shape of the sealing lip, on the other.

The plurality of openings can be formed as blind holes. The blind holes can have, e.g., a rectangular or square cross section and extend from the surface of the first main side into an interior region of the sealing lip. A depth of the blind holes can constitute two-thirds or more of a thickness of the sealing lip. A bottom of the blind holes can run parallel to the surface of the first main side. With this embodiment, an optimal elimination of flow separation in the case of an air stream striking the ventilation flap can be realized.

According to an embodiment, the sealing lip can have a groove, extending over a length of the sealing lip parallel to the edge region, for placing the sealing lip onto the flap body. The groove can be arranged and formed opposite to the rounded side of the sealing lip to place the sealing lip onto the edge region of the flap body. Alternatively, the groove can also be formed to be pushed onto a tongue, which extends in the form of an extension from the edge region of the flap body, so that a tongue-and-groove connection between the sealing lip and the flap body can be produced. This embodiment has the advantage that the sealing lip can be connected to the flap body in one especially rapid and simple to execute work step, and can also be easily replaced as part of maintenance operations.

According to another embodiment, in an attached state of the sealing lip to the flap body, the plurality of openings can be arranged within an overlap area of the sealing lip and the edge region of the flap body. In this case, the openings can also be made as through holes, which lead from a surface of the first main side of the sealing lip to the flap body.

Alternatively or in addition, in the attached state of the sealing lip to the flap body, the plurality of openings can be arranged outside of the overlap region of the sealing lip and the edge region of the flap body. Thus, a design of the sealing lip can be advantageously adapted to specific requirements or specifications via a number and position of the openings, so that optimal flow guidance of the air can be achieved.

Further, in an attached state of the sealing lip to the flap body, the first main side can abut without offset a main surface of the flap body. To this end, the flap body can have a suitable gradation. With this embodiment, therefore, flow separation can also be avoided at a transition between the flap body and the sealing lip.

The present invention also provides a ventilation flap for a vehicle HVAC system, whereby the ventilation flap has the following features: a flap body having a shaft region running along an axis of rotation of the ventilation flap, and a first flap wing and a second flap wing, arranged spaced apart on the shaft region to form an air guidance region of the ventilation flap; and a sealing lip according to any of the embodiments discussed above, which is connected to an edge region of the first flap wing.

The shaft region can be designed as a continuous or discontinuous tube-shaped middle region of the flap body suitable for receiving a shaft. The ventilation flap for receiving the air stream or air streams can be placed suitably rotatable on the shaft. The first and second flap wing can be designed as substantially rectangular elements extending from the shaft region so as to enclose a predetermined angle which determinates a ventilation flap volume. For example, the first and second flap wings can have different lengths, so that one of the flap wings extends along the entire shaft region and the other, e.g., only over about three-fourths of the shaft region. The first and second flap wings can also have different widths. The air guidance region, formed by the flap wings, can be designed for receiving the air in the ventilation flap and for suitable conducting of the air, e.g., to an air mixer of the vehicle HVAC system. The flap wing main sides, facing the air stream to be received, can at least in a partial region have a rib structure. The sealing lip can be glued, e.g., to the edge region of the first flap wing or be placed onto it.

According to an embodiment, the ventilation flap can have an additional sealing lip according to any one of the embodiments discussed above and be connected to an edge region of the second flap wing. Thus, stream separation along the entire contour of the flap body can be advantageously avoided.

According to an embodiment, the edge region of the first flap wing can form a tongue, onto which a groove of the sealing lip is pushed to form a tongue-and-groove connection. And the edge region of the second flap wing can form another tongue, onto which another groove of the additional sealing lip is pushed to form another tongue-and-groove connection. The tongue and the additional tongue can extend along the entire edge region of the first or second flap wing and each be designed, e.g., as a material extension of the flap body with a smaller thickness than the flap wing. The cross section of the material extension can be rectangular and run in the middle on the outer edge of the edge region of the first or second flap wing and thus form on both sides a shoulder of the edge region. The shape and depth of the sealing lip groove and the additional sealing lip can be formed complementary to the shape and height of the tongue, so that in the attached state the sealing lips sit flush on the tongues of the edge regions. A material thickness of the groove-forming regions of the sealing lip and the additional sealing lip can correspond to a width of the shoulders, formed by the tongue and the additional tongue, of the respective flap wing, so that in the attached state the sealing lips abut the flap body without offset. This embodiment offers the advantage that the sealing lips and the flap body can be joined together especially rapidly and simply and separated again, which can have a positive effect for the installation and maintenance of the ventilation flap.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an illustration of a main side of a ventilation flap according to an exemplary embodiment of the present invention;

FIG. 2 is an illustration of a section of another main side of the ventilation flap of FIG. 1; and

FIG. 3 is a perspective detail view of the flap body and sealing lip of the ventilation flap of FIGS. 1 and 2.

### DETAILED DESCRIPTION

In the following description of the preferred exemplary embodiments of the present invention, the same or similar reference characters are used for the elements with a similar action and shown in the different drawings, whereby a repeated description of these elements is omitted.

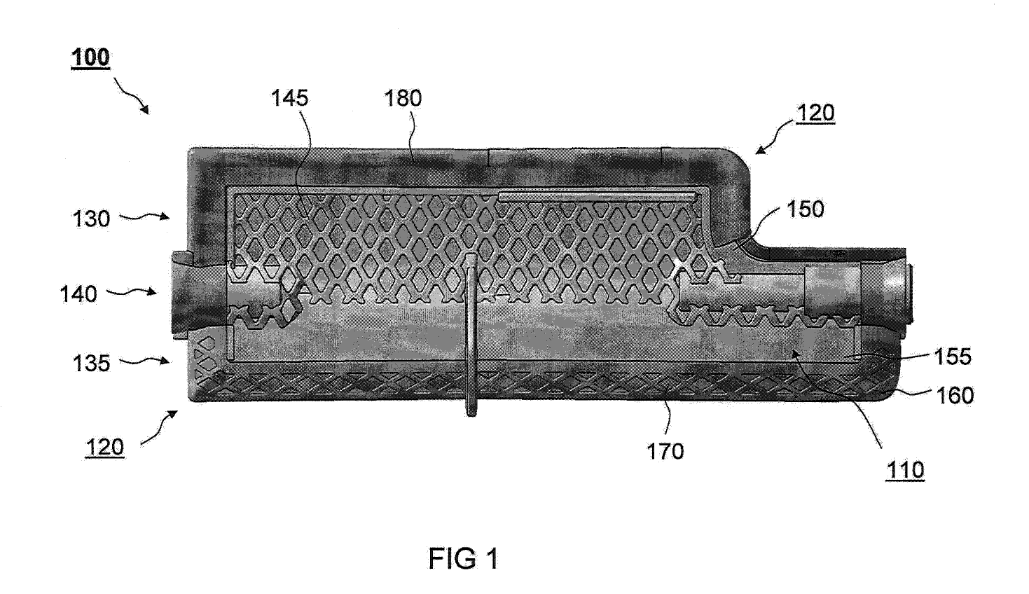

A ventilation flap according to an exemplary embodiment of the present invention is described below with use of FIGS. 1 through 3. The approach shown using the figures is based on a concept for an aerodynamically favorable design of the entire ventilation flap including the sealing lip area. In addition to the very highly stable, torsion-free flap body, an edge-free transition to the flexible sealing lip can be realized. In contrast, for example, to hammerhead profiles or thickenings at the sealing lip ends, considerable discontinuities can thus be avoided, so that now no or at least substantially reduced disadvantageous flow separations occur. A sealing lip contour of a ventilation flap of the invention has a radius greater than 1 mm, in contrast to conventional sealing lips, which have a smaller to considerably smaller radius, which under non-ideal conditions in the inflow can again lead to flow separations, therefore, noise generation. The same would apply to hammerhead profiles of the flaps, because here separations generally occur at the ends of the hammerhead. Still further, flow separations can be eliminated virtually totally by a placement of optimally positioned and dimensioned openings or cored-out areas in the sealing lip. In contrast to the foam-enclosed flaps, a ventilation flap, produced according to the approach presented here, is characterized by considerably lower production costs, a simpler production process, and a strong connection of the sealing lip material to the flap body.

FIG. 1 shows a plan view of an aerodynamically and acoustically optimized shutoff flap or ventilation flap 100 according to an exemplary embodiment of the present invention. Ventilation flap 100 can be used in an HVAC unit of a vehicle for receiving air and supplying the air to a mixer of the HVAC unit.

Shown are a flap body 110 and a first and second sealing lip 120. Flap body 110 has a first flap wing 130, a second flap wing 135, and a shaft region 140, to which the first 130 and second 135 flap wing are attached. In the exemplary embodiment, shown in FIG. 1, of shutoff flap 100, first flap wing 130 has a shorter length and a greater width than second flap wing 135. First flap wing 130 on a flat side, visible in the illustration in FIG. 1, has a plurality of closely spaced ribs 145, which serve to guide an air stream striking ventilation flap 100, when it is in use. Shaft region 140 has opposite receiving openings, so that ventilation flap 100 is engaged with a shaft and can be turned by it as needed. In the exemplary embodiment of ventilation flap 100, as shown in FIG. 1, first sealing lip 120 is connected to an edge region 150 of the first flap wing 130 and the second sealing lip 120 is connected to an edge region 155 of the second flap wing 135. The first and second sealing lips 120 are made of a soft elastic plastic material, which adjusts well to a contour of flap body 110.

The illustration in FIG. 1 shows that sealing lip 120, connected to edge region 155, is arranged on flap body 110, so that a first main side 160 of second sealing lip 120 faces the viewer's eye. Main side 160 has a plurality of openings 170, which in the form of a band forming a uniform pattern are distributed over an entire lengthwise extension of sealing lip 120 between their starting points on shaft region 140. In a central area of this band, openings 170 have a diamond-shaped cross section, whereas openings 170 in the edge regions of the band have a triangular cross section. An edge region surrounding the plurality of openings 170 of sealing lip 120 has no openings. First sealing lip 120, connected to edge region 150, is arranged, in contrast, on flap body 110, so that a second main side 180, opposite to the first main side, of first sealing lip 120 faces the viewer's eye. This second main side 180 of sealing lip 120 has no openings. An end section of first sealing lip 120 here has a width smaller by more than half than the rest of sealing lip 120. As the illustration in FIG. 1 shows, in the exemplary embodiment of the shutoff flap or ventilation flap 100 shown here, end sections of shaft region 140 are also covered with a sealing material. This material can be the same or different from the soft elastic plastic material used for sealing lips 120.

In the exemplary embodiment of ventilation flap 100, as shown in FIG. 1, flap body 110 is reinforced by numerous closely spaced ribs 145. Ribs 145 of flap body 110 and openings 170 of second sealing lip 120 serve to support the aerodynamic shape of ventilation flap 110 and to avoid flow separation of the air striking the ventilation flap.

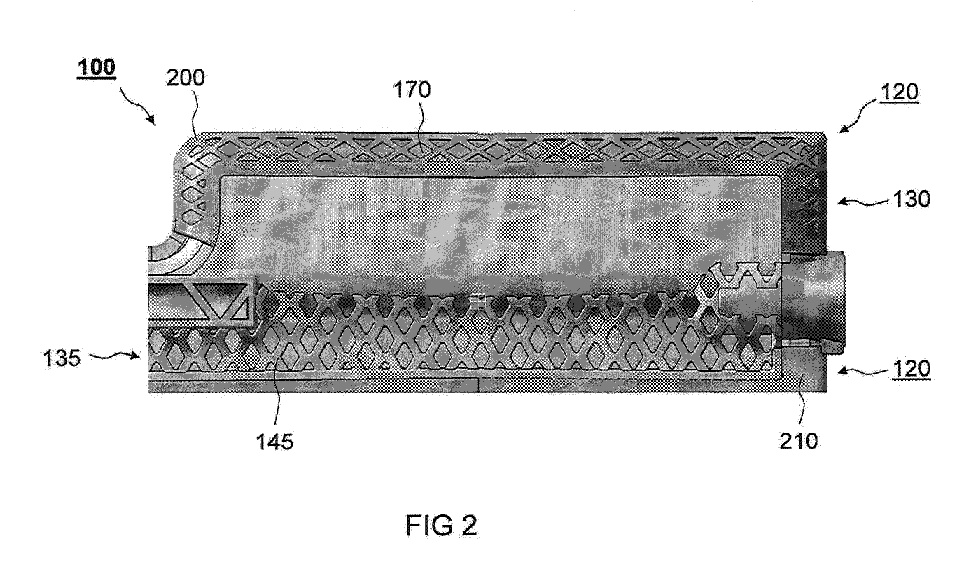

FIG. 2 shows an illustration of a section of ventilation flap 100 of FIG. 1 rotated around a longitudinal axis. Accordingly, a first main side 200, opposite to the second main side, of first sealing lip 120 now faces the viewer's eye. As the illustration in FIG. 2 shows, the first main side of the first sealing lip also has openings 170. Openings 170 here form the same structure as on the first main side, visible in FIG. 1, of second sealing lip 120. Conversely, a second main side 210, facing the viewer here, of second sealing lip 120 has no openings. Also, the side facing the viewer here of flap wing 130, different from the side facing the viewer in FIG. 1, has no ribs, whereas the side facing the viewer of flap wing 135, different from the side facing the viewer in FIG. 1, has the plurality of ribs 145. The structure of ribs 145, as used in this exemplary embodiment of ventilation flap 100, is the same for both flap wings 130, 135.

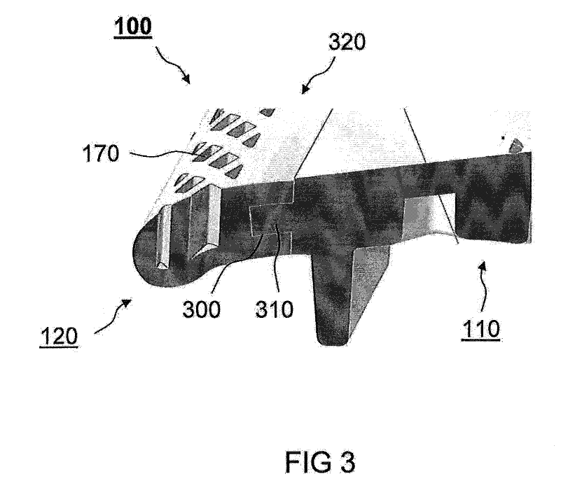

FIG. 3 shows in a perspective detail view a cross section through ventilation flap 100 of FIGS. 1 and 2. Shown is a connection region of flap body 110 with one of sealing lips 120. It is evident from the illustration that sealing lip 120 is attached to an edge region of flap body 110 by means of a tongue-and-groove connection. In the edge region shown in the illustration, this can be the edge region of the first flap wing or the edge region of the second flap wing of flap body 110. The tongue-and-groove connection is made so that a groove 300 of sealing lip 120 is accurately fitted in a tongue 310, which is formed on an outer edge of the edge region of flap body 110. In the exemplary embodiment shown here of the tongue-and-groove connection, groove 300 and tongue 310 have complementary rectangular cross sections. The tongue-and-groove connection here allows for a transition between flap body 110 and sealing lip 120 without offset. It is readily evident in FIG. 3 that sealing lip 120 is bead-shaped, i.e. a side not connected to flap body 110 of sealing lip 120 has rounded edges. In the exemplary embodiment, shown in FIG. 3, of ventilation flap 100, the curvature of sealing lip 120 has a radius of less than 2 mm. Other radiuses are also possible. Further, the illustration in FIG. 3 clearly shows that openings 170 of sealing lip 120 here are blind holes. The blind holes or cored-out areas 170 are formed by parallel walls of the sealing lip interior area. A depth of blind holes 170 extends over the better part of the interior region of sealing lip 120. Further, it is clear from the illustration in FIG. 3 that openings 170 are arranged outside an overlapping area 320 of sealing lip 120 and the edge region of flap body 110.

Alternatively to the described exemplary embodiments, a partial foam enclosure of the flap in the sealing lip area only is also conceivable.

The described exemplary embodiments are selected only by way of example and can be combined with one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A sealing lip for an edge region of a flap body of a ventilation flap of a vehicle HVAC system, the sealing lip comprising:
a first main side; and
a second main side opposite to the first main side,
wherein the first main side has a plurality of openings.

2. The sealing lip according to claim 1, wherein a bar arranged between two neighboring openings of the plurality of openings has a smaller width than in each one of two adjacent openings.

3. The sealing lip according to claim 1, wherein the plurality of openings is formed as blind holes.

4. The sealing lip according to claim 1, wherein the sealing lip has a groove extending over a length of the sealing lip parallel to the edge region for placing the sealing lip onto the flap body.

5. The sealing lip according to claim 1, wherein, in an attached state of the sealing lip to the flap body, the plurality of openings is arranged within an overlap area of the sealing lip and the edge region of the flap body.

6. The sealing lip according to claim 1, wherein, in an attached state of the sealing lip to the flap body, the plurality of openings is arranged outside the overlap area of the sealing lip and the edge region of the flap body.

7. The sealing lip according to claim 1, wherein, in an attached state of the sealing lip to the flap body, the first main side abuts without an offset to a main surface of the flap body.

8. A ventilation flap for a vehicle HVAC system, the ventilation flap comprising:
a flap body having a shaft region running along an axis of rotation of the ventilation flap;
a first flap wing and a second flap wing, which are arranged spaced apart on the shaft region to form an air guidance region of the ventilation flap; and
a sealing lip according to claim 1 being connected to an edge region of the first flap wing.

9. The ventilation flap according to claim 8, wherein the ventilation flap has an additional sealing lip connected to an edge region of the second flap wing.

10. The ventilation flap according to claim 8, wherein the edge region of the first flap wing forms a tongue, onto which a groove of the sealing lip is placed to form a tongue-and-groove connection and/or the edge region of the second flap wing forms another tongue onto which another groove of the additional sealing lip is placed to form another tongue-and-groove connection.
